(19) United States
(12) Patent Application Publication
(10) Pub. No.: US 2008/0141041 A1
(43) Pub. Date: Jun. 12, 2008

(54) Wireless encryption key integrated HDD

(75) Inventors: Donald Molaro, Cupertino, CA (US); Richard New, San Jose, CA (US); Jorge Campello De Souza, Cupertino, CA (US)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/635,996

(22) Filed: Dec. 8, 2006

(51) Int. Cl. H04L 9/00

(52) U.S. Cl. 713/193

(57) ABSTRACT

A wireless encryption key integrated storage system is provided to prevent unauthorized access of data stored on the storage device without secure authentication between the storage device and a key device. In one embodiment, a data storage device comprises a magnetic disk; a head assembly having a read/write head which read and write data from/on the magnetic disk; a wireless transceiver configured to receive and transmit wireless signals from a key device, the wireless signals comprising information used to establish a secure authorization between the data storage device and the key device to access secured content in the magnetic disk; and a processor configured to encrypt/decrypt data transferred between the data storage device and the key device.

### BACKGROUND OF THE INVENTION

Embodiments in accordance with the present invention relate generally to hard disk drives or other data storage devices. More particularly, embodiments of the present invention provide a data storage device that communicates with a remote device to establish an authorization before the data storage device can be operated.

Hard disk drives and other data storage devices are commonly used in computers, digital music players, and other electronic devices to provide a reliable and effective location for data storage. Miniaturization and increases in reliability have allowed data storage devices to be incorporated into electronic devices that are portable and can be easily transported with users as they travel to different locations. This has empowered users with a great deal of flexibility in that the data being stored on the data storage device is available to the user even at a different location. A common example of this may be a laptop or portable computer, which may use a smaller hard disk drive with a smaller form factor to enhance portability. For example, a laptop computer can be used at work, and then transported to a different building at work or moved home for continued use at a different location.

However, as electronic devices become more portable, there is also an increasing probability that the electronic devices will become lost or stolen as users operate the electronic devices in different locations. The electronic device may be accidentally left behind, forgotten in transit, misplaced, or stolen by others. Not only does this present a problem in that the electronic device is no longer available to the user, but any data stored on the device may be easily obtainable by a third party. Any sensitive information such as business plans, financial information, or company data that was present on the data storage device within the electronic device may now be available to a third party. As can be expected, this poses a significant problem to the owner of the laptop and/or the company.

Several approaches have been previously employed to try to solve the problem of losing or misplacing an electronic device containing sensitive information within its storage areas. Japanese Patent Laid-Open No. 2000-222289 discusses the use of a wireless transmitter that communicates with a central processing unit (CPU) located within the electronic device, such as a laptop. In this case the CPU of the host-computing device controls encryption and decryption of the data on the hard disk drive. When the wearable transmitter is in range of the receiver in the CPU, the encrypted data is decrypted and stored unencrypted onto the hard disk drive. When the user and wearable transmitter leave the location, the CPU encrypts the unencrypted data and saves the encrypted file, and then deletes the unencrypted file. One problem with this approach is that the unencrypted file is temporarily stored on the hard disk drive within the electronic device. For example, if power is removed from the device or the operating system on the device crashes, the unencrypted file remains in the hard disk drive and potentially can be accessed by others.

Japanese Patent Laid-Open No. 2002-259220 discusses the application of restricting the hard disk drive power until a portable wireless transmitter is within range. By restricting power to hard disk drive components such as the spindle/VCM driver or hard disk drive controller, data on the hard disk drive cannot be read until the transmitter is in range of the device as the device is normally in a powered down state. However, the data on the hard disk drive may be potentially accessed by putting the magnetic disks containing the data on a spin stand, replacing the PCB board, and manually powering up specific components within the hard disk drive, thus overriding the hard disk drive's power control. Additionally, the data on the hard disk drive is not encrypted in any way, providing others with potential access to the device once power has been established.

Despite the availability of the above-described techniques new devices for safely storing data on a mobile storage device are desired.

### BRIEF SUMMARY OF THE INVENTION

Embodiments of the present invention provide a wireless encryption key integrated storage system to prevent unauthorized access of data stored on the storage device. In accordance with embodiments of the present invention, the storage device incorporates an encryption device directly on the disk drive that communicates over a short-range wireless link to a key device carried by an authorized person. This communication through authentication establishes authorization and access to an encryption/decryption key to be used for encrypting and decrypting the data on the disk. In this way, both authentication and key management are achieved.

An embodiment of a data storage device in accordance with the present invention comprises, a magnetic disk, a head assembly having a read/write head which read and write data from/on the magnetic disk, and a wireless transceiver configured to receive and transmit wireless signals from a key device, the wireless signals comprising information used to establish a secure authorization between the data storage device and the key device to access secured content in the magnetic disk. The data storage device further comprises a processor configured to encrypt/decrypt data transferred between the data storage device and the key device.

An embodiment of a data storage system in accordance with the present invention comprises, a key device configured to receive and transmit wireless signals, and a data storage device. The data storage device comprises a magnetic disk, a head assembly having a read/write head which read and write data from/on the magnetic disk, and a wireless transceiver configured to receive and transmit wireless signals from a key device, the wireless signals comprising information used to establish a secure authorization between the data storage device and the key device to access secured content in the magnetic disk. The data storage system further comprises a processor configured to encrypt/decrypt data transferred between the data storage device and the key device.

An alternative embodiment of a data storage device in accordance with the present invention comprises a magnetic disk containing encrypted information, a head assembly having a read/write head which read and write data from/on the magnetic disk, and a wireless transceiver configured to receive and transmit wireless signals from a key device, the wireless signals comprising information used to establish a secure authorization between the data storage device and the key device to access secured content in the magnetic disk. The data storage device further comprises a memory including a computer program to encrypt/decrypt data transferred between the data storage device and the key device, and a processor configured to execute the computer program.

### BRIEF DESCRIPTION OF THE DRAWINGS

FIG. 1 is an exemplary simplified diagram of a data storage system that uses secure authentication to enable access according to an embodiment of the present invention.

FIG. 2 is an exemplary simplified perspective view of a hard disk drive (HDD) that can be used as a data storage device within computing device according to an embodiment of the present invention.

FIG. 3 is an exemplary simplified functional block diagram of the HDD according to an embodiment of the present invention.

FIG. 4 is an exemplary diagram of a simplified process flow showing wireless communication between a data storage device and a key device to establish a secure authorization according to an embodiment of the present invention.

FIG. 5 is an exemplary diagram of a simplified process flow showing wireless communication between a data storage device and a key device after a secure authorization has been established according to an embodiment of the present invention.

### DETAILED DESCRIPTION OF THE INVENTION

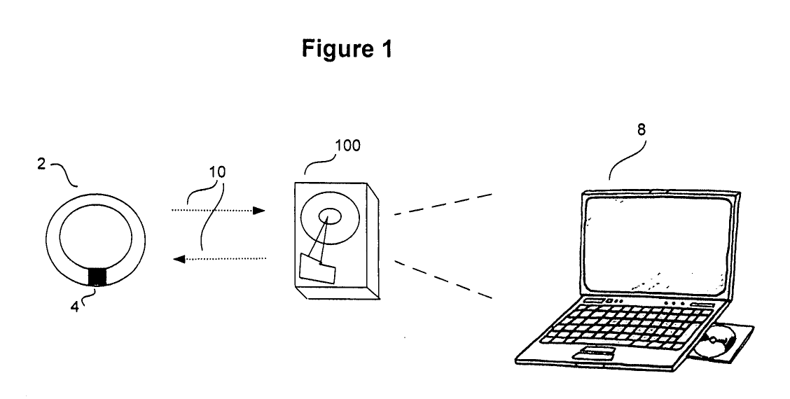

FIG. 1 is a simplified exemplary diagram of a data storage system that uses secure authentication to enable access according to an embodiment of the present invention. A computing device 8 includes a data storage device 100 used to store sensitive data, such as financial documents, business plans, etc. that are not meant to be accessed by other parties. The computing device 8 may be a laptop computer, a personal digital assistant (PDA), an external hard drive, or any sort of electronic device that includes the data storage device 100. The data storage device 100 may be a hard disk drive, a solid-state memory device such as a USB or flash drive, or other device that stores data. The data storage device 100 is typically contained within the housing of the computing device 8. For example, a hard disk drive may be contained within the external housing of the computing device 8. The computing device 8 may also possess an operating system used to operate the device, such as Windows XP, Linux, Windows CE, Palm, or the like.

A key device 2 is provided to the user to access the data stored on data storage device 100. The key device 2 may be a wearable or portable item that can be easily transported or carried on the body of the user. For example, the key device may be formed into a commonly worn piece of personal property, such as a ring, a necklace, or a watchband. Other potential key devices include wallets, earrings, and belt buckles, and are not limited to those described herein. The key device 2 includes a wireless transceiver 4 for sending and receiving authentication information to the data storage device 100. The authentication information is sent directly to the data storage device 100 and does not pass through the operating system of computing device 8. Hence, the authentication process is independent of the operating system of computing device 8 and any errors or security failures in the operating system do not affect the security of data storage device 100. Wireless transmissions 10 are sent and received by wireless transceivers in key device 2 and storage device 100. Wireless transmissions 10 may be sent in a variety of different wireless protocols, including but not limited to TCP/IP, 802.11, Bluetooth, and radio signals. In addition, the range of wireless transmissions 10 may be limited to conserve the power of both the data storage device 100 and the key device 2. For example, the range of wireless transmissions 10 may be 10 feet to allow for a compromise between device usability and security. Of course, other transmission ranges may also be implemented as well. The wireless transceiver 4 may possess a low-power or “sleep” mode that conserves power when sending and receiving of wireless transmissions is not being performed. In this case, the wireless transceiver 4 may use a polling function to periodically check if a message has been sent to it from the data storage device 100. Alternatively the device may include a “button” to wake up the key device and start transmitting.

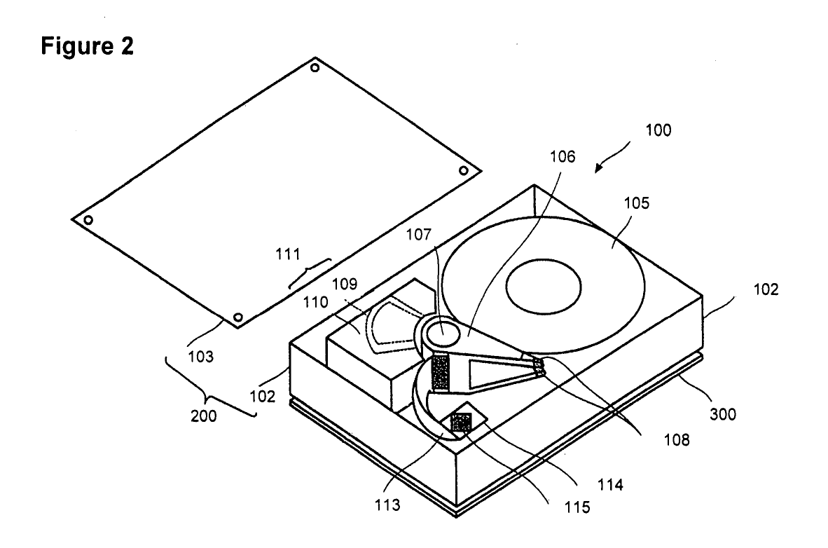

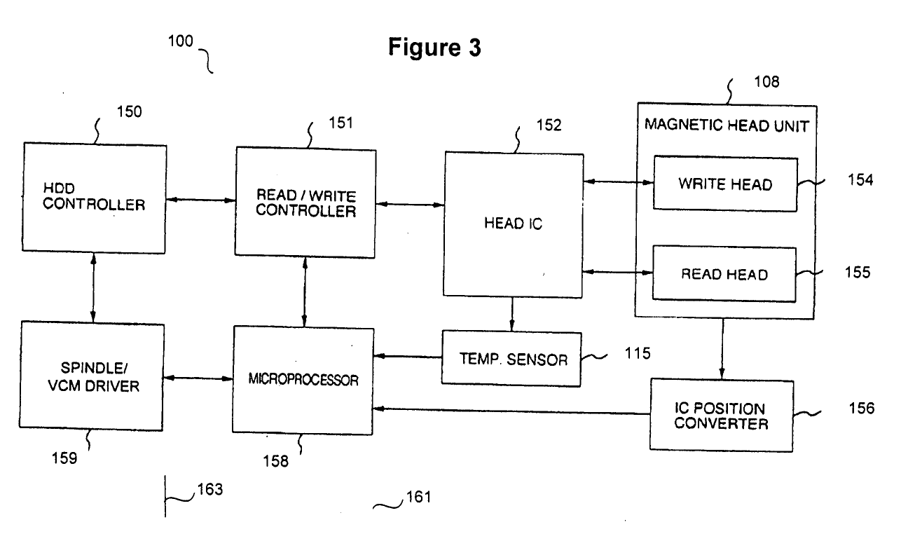

FIG. 2 is an exemplary simplified perspective view of a hard disk drive (HDD) that can be used as the data storage device 100 within the computing device 8 according to an embodiment of the present invention. FIG. 3 is an exemplary simplified functional block diagram of the HDD according to an embodiment of the present invention. As shown in FIG. 2, the HDD 100 includes a disk enclosure 200 having a top cover 103 installed to seal the open top of a box-shaped base 102, which may be made, for instance, of an aluminum alloy. The top cover 103 is made, for instance, of stainless steel, and is fastened by fasteners to the base 102 with a sealing member (not shown), which is shaped like a rectangular frame. The disk enclosure 200 contains a spindle motor (not shown), which comprises, for instance, a hub-in, three-phase DC servo motor. The spindle motor imparts rotary drive to a magnetic disk 105, which is a storage medium. One or more units of the magnetic disk 105 are installed in compliance with the storage capacity requirements for the HDD 100. A card 300 is attached to the lower surface of base 102. The card 300 carries a signal processing circuit, a drive circuit for spindle motor, and other components described later.

An actuator arm 106 is mounted within the disk enclosure 200. The middle section of the actuator arm 106 is supported above the base 102 so that it can pivot on a pivot axis 107. A composite magnetic head 108 is mounted on one end of actuator arm 106. A VCM (voice coil motor) coil 109 is mounted on the remaining end of actuator arm 106. The VCM coil 109 and a stator 110, which is made of a permanent magnet and fastened to the disk enclosure 200, constitute a VCM 111. When a VCM current flows to the VCM coil 109, the actuator arm 106 can move to a specified position over the magnetic disk 105. This movement causes the composite magnetic head 108 to perform a seek operation. The magnetic disk 105 is driven to rotate around a spindle axis of the spindle motor. When HDD 100 does not operate, magnetic disk 105 comes to a standstill.

As seen in FIG. 3, the composite magnetic head unit 108 may be a combination of an ILS (integrated lead suspension) (not shown), a read head 155, which comprises a GMR (giant magnetoresistive) sensor, and a write head 154, which comprises an induction-type converter. The read head 155 reads servo information when the head unit 108 reads data, writes data, or performs a seek operation. For a data read operation, the read head 155 also reads data between items of servo information. For a data write or data read, the actuator arm 106 pivots over the surface of the magnetic disk 105 during its rotation so that the composite magnetic head unit 108 performs a seek operation to scan for an arbitrary track on the magnetic disk 105. In this instance, the ABS (air bearing surface) of composite magnetic head unit 108, which faces the magnetic disk 105, receives a lift force due to an air current generated between the ABS and the magnetic disk 105. As a result, the composite magnetic head unit 108 constantly hovers a predetermined distance above the surface of the magnetic disk 105.

The read head 155 and write head 154, which constitute the composite magnetic head unit 108, are electrically connected to the head IC 152. The head IC 152 is mounted on a lateral surface of the pivot axis 107 of the actuator arm 106. One end of a flex cable 113 is connected to the head IC 152 to permit data exchange with the card 300. A connector 114 is attached to the remaining end of the flex cable 113 for connecting to the card 300. A temperature sensor 115 may be mounted on the upper surface of the connector 114 to measure the temperature inside the disk enclosure 400 (the ambient temperature for the magnetic disk 105).

The card 300 includes electronic circuits shown in FIG. 3, which control the operation of the actuator arm 106 and perform data read/write operations in relation to the magnetic disk 105. The card 300 controls the rotation of the magnetic disk 105 through a spindle/VCM driver 159 and drives the VCM coil 109 to control the seek operation of the actuator arm 106.

The HDD controller 150 transfers data between an external host (not shown) and the magnetic disk 105, generates a position error signal (PES) from servo data, and transmits the positional information about the composite magnetic head 108 to a read/write controller 151 and a microprocessor 158. In accordance with the control information from the microprocessor 158, the spindle/VCM driver 159 drives the VCM coil 109 to position the composite magnetic head 108 on the specified track. The positioning of the magnetic head unit 108 is determined by an IC position converter 156 in response to a signal from the magnetic head unit 108. The microprocessor 158 further interprets a command that is transmitted from an external host (not shown) through the HDD controller 150, and instructs the HDD controller 150 to perform a data read/write operation in relation to an address specified by the command. In accordance with the positional information about the composite magnetic head 108, which is generated by the HDD controller 150, the microprocessor 158 also transmits control information to the spindle/VCM driver 159 for the purpose of performing a seek operation to position composite magnetic head 108 on a specified track. The microprocessor 158 additionally performs encryption and decryption of sectors on the magnetic disk 105, depending upon whether or not secure authorization has been established between data storage device 100 and key device 2. The microprocessor may employ a dedicated hardware encryption & decryption circuit so that the data storage and retrieval rate remains comparable to HDD devices without encryption. Sensitive data on sectors of the magnetic disk 105 are always encrypted, and are only decrypted in the presence of the key device 2 in close proximity and a secure authorization having been established. In a specific embodiment, only certain sectors of data storage device 100 need to be encrypted. For example, a section of magnetic disk 105 may be unencrypted to serve as unsecured storage, perhaps to be used for the operating system or other data which is considered to be less sensitive. Another portion of the disk may be a secured portion of the disk, which is only accessible with key device 2 present. In another specific embodiment, all sectors of data storage device 100 are encrypted. Access to specific portions of the disk may be controlled by the presence or absence of the wireless key device.

The wireless transceiver 163 is used to send and receive wireless transmissions to the corresponding wireless transceiver 4 in the key device 2. The wireless transmissions may comprise information used to establish a secure authorization between the data storage device 100 and the key device 2. As seen in FIG. 3, the wireless transceiver 163 is linked to a processing module 161, which processes the signal being received by the wireless transceiver 163. Processing of the signal may comprise converting the signal or preprocessing the signal for interpretation by the microprocessor 158. Alternatively, processing of the signal may be performed completely by the processing module 161. The processing module 161 may also serve to help formulate the signal to be sent to the key device 2. In a specific embodiment of the present invention, the processing module 161 may be integrated with the wireless transceiver 163. In another specific embodiment of the present invention, the processing module 161 may be integrated with the microprocessor 158. In yet another specific embodiment, the processing module 161 may additionally comprise a non-volatile recording medium configured to store firmware used to establish a secure authorization between the data storage device 100 and the key device 2 by sending wireless transmissions between the wireless transceiver 163 and the key device 2.

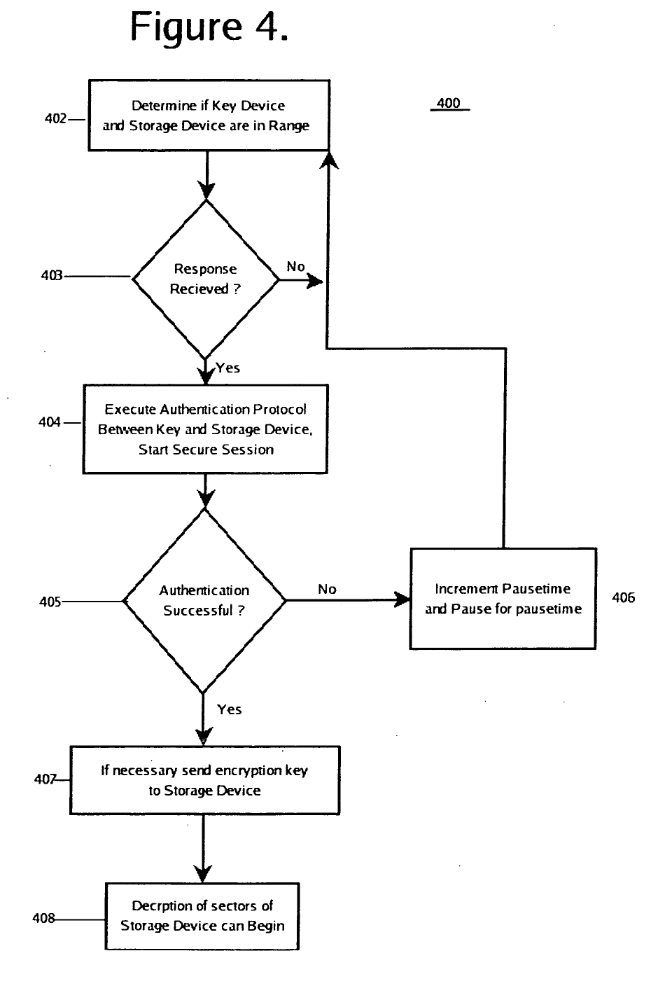

FIG. 4 is an exemplary diagram of a simplified process flow 400 showing wireless communication between a data storage device and a key device to establish a secure authorization according to an embodiment of the present invention. The process flow 400 includes step 402 for determining if a key device 2 and data storage device 100 are in range, step 403 for determining if a response from the key device 2 is received, step 404 for executing an authentication protocol between the key and the storage device, and to begin the secure session in the storage device. In step 405 the storage device determines if the authentication protocol has been successful, if it has the process continues to step 407 if not it continues to step 406. In step 406 the device increments a counter which specifies a period to wait and waits that period of time before returning to step 402. In step 407 the key to decrypt data on the storage device is sent from the wireless key to the storage device over the established authenticated communications channel. In step 408 as the device is accessed from the host computer (not shown) it decrypts and encrypts data as required.

In step 402, a determination is made as to whether the key device and data storage device are in range of each other. This process may be initiated by any of the following, but not limited to, a data request for the data storage device 100, powering on of the computing device 8, or a periodic check to determine if the key device 2 is within range. While the data storage device 100 may interact and use operating system features to begin initiating the authentication process, it is to be understood that the authentication process can be performed independently of the operating system as well. The specific initiator of step 402 may be preset by the manufacturer of the storage device 100 or set within the firmware of the storage device 100, depending upon the specific implementation used. A wireless message is then sent through the wireless transceiver 163 to determine if the key device 2 is in range. If the key device 2 is out of range or non-responsive in step 403, the data storage device 100 may immediately reinitiate step 402, wait for a designated period before reinitiating step 402, or cease communication. If the key device 2 is responsive in step 403, the key device 2 is fully powered on out of a “sleep” or low-power state if employed and the authentication process can begin between the key device 2 and the data storage device 100. Alternatively, the key device 2 could also be used to determine if the data storage device 100 is in range, by similarly transmitting a wireless message from the key device 2 to the data storage device 100 and receiving a response from the data storage device 100.

In step 404, the Key device and the storage device execute an authentication protocol which will establish a secure session and communications channel between to the two devices in which sensitive information, such as encryption/decryption keys, may be passed.

In step 406, the data storage device 100 determines if the key device 2 has received the wireless message. If the authentication protocol is not successful, for any reason, then the storage device will return to step 402.

In step 407, the wireless key device sends and the data storage receives the decryption key for the data on the storage device. This transmission occurs over the secure authenticated channel established in step 404.

In addition to encrypting the message using public key cryptography, the message may be additionally protected by using a digital certificate. A certificate authority functions as a trusted party known to both the key device 2 and the data storage device 100. For example, if the same company issues both the key device 2 and the data storage device 100, the certificate authority will be a trusted party known to both. The certificate authority possesses both a public and private key, of which the private key is closely guarded. The public key of the data storage device 100 may be encrypted using the private key of the certificate authority. This constitutes a digital certificate that can be used to help authenticate different devices, in this case the data storage device 100 and the key device 2 to each other using the certificate authority. The certificate may be stored in the data storage device 100 with the unique public and private keys of the data storage device 100.

In a specific embodiment, counters may be maintained to check the number of times messages are sent in step 404 or the number of times an incorrect message is sent as identified in step 405 to enhance security. For example, preprogrammed settings may only permit a fixed number of encrypted messages to be sent in step 404 until the authentication process is stopped for a certain period of time. Correspondingly, only a certain number of incorrect decrypted messages may be accepted in step 405 until the authentication process is halted.

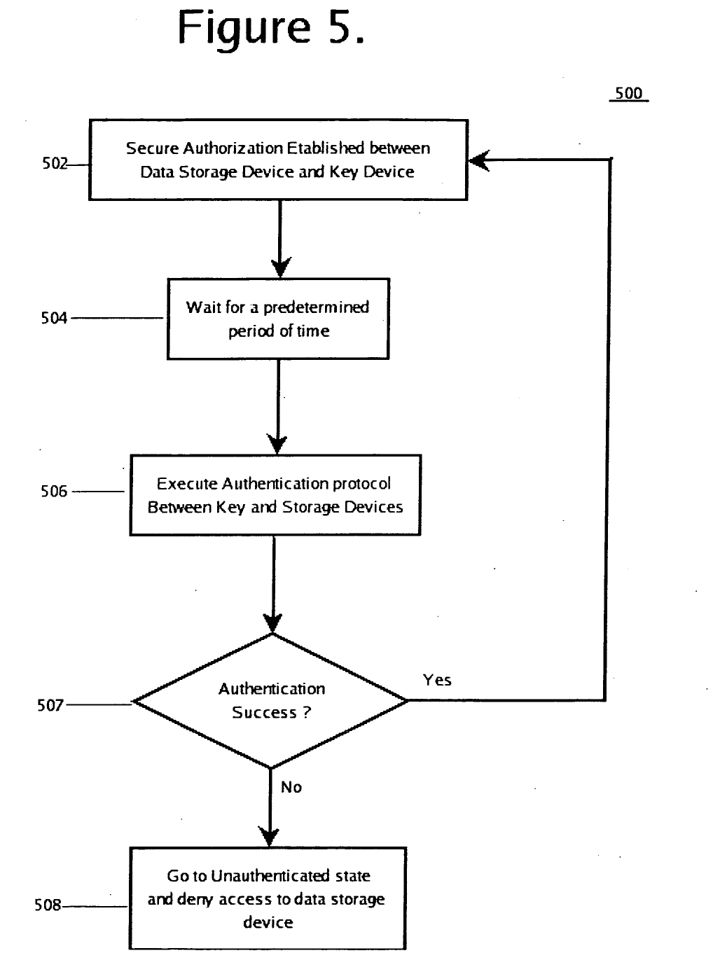

The secure authorization established between data storage device 100 and key device 2 does not last indefinitely. FIG. 5 is an exemplary simplified process flow 500 showing wireless communication between a data storage device and a key device according to an embodiment of the present invention, after a secure authorization has already been obtained in step 502, for instance, using the process 400 of FIG. 4. The process flow 500 is used to maintain a secure authorization between the key device and the data storage device. The process flow 500 includes step 504 for waiting until a predetermined period to elapse, step 506 for reestablishing the secure channel between the wireless key device and the data storage device The process also includes step 507 for determining if the authentication step 506 succeeds or fails, and step 508 for putting the data storage device into an unauthenticated state.

Following the conclusion of the process flow 400, a secure authorization has been established between the key device 2 and the data storage device 100 (step 502). This authorization must be periodically refreshed to ensure that the key device 2 is still within the immediate vicinity of the storage device 100. In step 504, operations to the encrypted areas of the storage device 100 are permitted until a predetermined time has elapsed. After interval, in step 506, the data storage device reestablishes the secure authenticated channel with the wireless key device. If the authentication succeeds the device returns to the authenticated state in step 502. If the authentication in step 506 fails the device goes to an unauthenticated state and will deny access to the encrypted areas of the data storage device.

In another embodiment of the present invention, the wireless key 2 may be integrated within a component of the computing device 8 to prevent the data storage device 100 from functioning when separated from the computing device 8. For example, if the computing device 8 is a laptop or portable computer, the wireless key 2 may be integrated within the case, circuit board, or other component of the computer in such a manner that it may not be easily removed from the case or circuit board. In this event, the data storage device 100 would allow access to its contents so long as the data storage device 100 was contained or in close proximity to the computing device 8. The data storage device 100 would not function when removed from the host system.

By requiring secure authorization to be established through the key device 2 directly to the data storage device 100, several forms of attack to obtain the data contained on the data storage device 100 can be prevented. For example, hardware-based attacks by manually resetting the data storage device password will not work, because secure authentication with the key device 2 is still required independent of the data storage device password. Removing the circuit board present in the data storage device 100 and replacing it with one without encryption features will be fruitless, as the data on the data storage device 100 is maintained in an encrypted state. Similarly, removing the disk platters and placing them in a “spin stand” will not prove successful, as the data on the data storage device 100 is maintained in an encrypted state. In addition, accessing the data through a network without the authorized user being present will not work, as a secure authorization cannot be established.

In yet another embodiment of the present invention, the data storage device 100 may act as a removable storage when viewed by the operating system of the computing device 8, while not actually being removed from computing device 8. When the user and the key device 2 are present, the data storage device 100 will appear available to the operating system; but without the user and the key device 2 present, the data storage device 100 will appear to have “ejected” itself, while still being physically present in the computing device 8.

In still another embodiment of the present invention, the electronics or motor within the data storage device 100 will not function without having established a secure authorization between the data storage device 100 and the key device 2. Power may be temporarily suspended to components within the data storage device 100, or the motor may be prevented from operating until a secure authorization was established.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

What is claimed is:

1. A data storage device comprising:
a magnetic disk;
a head assembly having a read/write head which read and write data from/on the magnetic disk;
a wireless transceiver configured to receive and transmit wireless signals from a key device, the wireless signals comprising information used to establish a secure authorization between the data storage device and the key device to access secured content in the magnetic disk; and
a processor configured to encrypt/decrypt data transferred between the data storage device and the key device.

2. The data storage device of claim 1 wherein the controller comprises:
a controller configured to control the head assembly to read/write data to/from the magnetic disk;
a hard disk drive control configured to transfer data between an external host and the magnetic disk generating a position error signal from servo data and transmit positional information about the head assembly to a read/write controller;
a spindle/VCM driver configured to control movement of an actuator arm over the magnetic disk whereby the head assembly is mounted on the actuator arm, and to control movement of the magnetic disk;
a microprocessor configured to interpret commands transmitted from the hard disk drive controller and instruct the hard disk drive controller to perform a read/write operation based on the address specified by a command;
a head IC unit configured to receive and communicate data to and from the head assembly; and
an IC position converter which determines the position of the head assembly.

3. The data storage device of claim 1 wherein the information being transmitted is encrypted by public or private keys.

4. The data storage device of claim 1 wherein the information being transmitted is first encrypted by a private key known to the data storage device, then decrypted by a public key known to the key device corresponding to the private key.

5. The data storage device of claim 1 wherein at least a portion of the information used to establish a secure authorization between the data storage device and the key device is randomly generated.

6. The data storage device of claim 1 wherein the information being transmitted comprises a digital certificate.

7. The data storage device of claim 1 wherein the magnetic disk includes a plurality of sectors, and wherein one or more of the plurality of sectors containing the secured content are encrypted prior to establishing the secure authorization between the data storage device and the key device.

8. The data storage device of claim 1 wherein the magnetic disk includes a plurality of sectors, and wherein after establishing the secure authorization between the data storage device and the key device, at least one of the plurality of sectors containing the secured content is decrypted.

9. A data storage system comprising a key device configured to receive and transmit wireless signals and a data storage device, the data storage device comprising:
a magnetic disk;
a head assembly having a read/write head which read and write data from/on the magnetic disk;
a wireless transceiver configured to receive and transmit wireless signals from a key device, the wireless signals comprising information used to establish a secure authorization between the data storage device and the key device to access secured content in the magnetic disk; and
a processor configured to encrypt/decrypt data transferred between the data storage device and the key device.

10. The data storage system of claim 9 wherein the information being transmitted is encrypted by public or private keys.

11. The data storage system of claim 9 wherein the information being transmitted comprises a digital certificate.

12. The data storage system of claim 9 further comprising a computing device coupled to the data storage device.

13. The data storage system of claim 12 wherein the data storage device is unavailable to an operating system used in the computing device when the secure authorization between the data storage device and the key device cannot be established.

14. The data storage system of claim 12 wherein the data storage device and the key device communicate with each other to establish the secure authorization therebetween independently of an operating system used in the computing device.

15. The data storage system of claim 12 wherein the key device is incorporated into a component of the computing device.

16. The data storage system of claim 15 wherein the component is a computer case or a circuit board of the computing device.

17. A data storage device comprising:
a magnetic disk containing encrypted information;
a head assembly having a read/write head which read and write data from/on the magnetic disk;
a wireless transceiver configured to receive and transmit wireless signals from a key device, the wireless signals comprising information used to establish a secure authorization between the data storage device and the key device to access secured content in the magnetic disk;
a memory including a computer program to encrypt/decrypt data transferred between the data storage device and the key device; and
a processor configured to execute the computer program.

18. The data storage device of claim 17 wherein the computer program comprises:
code for determining if the key device is in range for wireless transmission;
code for receiving a randomly generated message from the key device;
code for creating an encrypted message from the randomly generated message using a private key, the private key being one of a set of paired cryptographic keys;
code for sending the encrypted message to the key device, the key device decrypting the encrypted message received from the data storage device using a public key paired with the private key, and verifying that the decrypted message which is decrypted from the encrypted message received by the key device from the data storage device is identical to the randomly generated message; and
code for, if the decrypted message from the key device is identical to the randomly generated message, beginning decryption of the secured content in the magnetic disk.

19. The data storage device of claim 17 wherein the magnetic disk includes a plurality of sectors, and wherein one or more of the plurality of sectors containing the secured content are encrypted prior to establishing the secure authorization between the data storage device and the key device.

20. The data storage device of claim 17 wherein the magnetic disk includes a plurality of sectors, and wherein after establishing the secure authorization between the data storage device and the key device, at least one of the plurality of sectors containing the secured content is decrypted.
